(19) United States
(12) Patent Application Publication
(10) Pub. No.: US 2007/0252115 A1
(43) Pub. Date: Nov. 1, 2007

(54) THERMOCHROMIC ELASTIC ARTICLES

(76) Inventors: Kelly D. Arehart, Roswell, GA (US); Scott S. Englebert, Cumming, GA (US); John Gavin MacDonald, Decatur, GA (US)

Correspondence Address: KIMBERLY-CLARK WORLDWIDE, INC.;Catherine E. Wolf, 401 NORTH LAKE STREET, NEENAH, WI, 54956, US

(21) Appl. No.: 11/380,682

(22) Filed: Apr. 28, 2006

(51) Int. Cl. C09K 9/00

(52) U.S. Cl. 252/583

(57) ABSTRACT

Disclosed herein are thermochromic elastic articles suitable for a variety of uses. The thermochromic elastic articles include at least one elastic polymeric composition having at least one thermochromic pigment substantially uniformly dispersed therein, and the elastomeric polymers include such as elastomeric emulsion-based polymers and elastomeric solution-based polymers. Such thermochromic elastic articles are highly useful for use in protective wear products, health care and medical care products, bandages and the like, and are capable of signaling environmental temperature change or temperature change in a wearer or user via a change in color. Additionally provided are articles of manufacture including the thermochromic elastic articles, such as articles including without limitation gloves, medical wraps, garments, and stress indicating articles.

### BACKGROUND OF THE INVENTION

Elastic articles have been treated with indicator chemicals to provide a visual indication of a range of triggering events. For example, protective wear such as gloves, for example surgical gloves, may be provided with indicator chemicals that change color in response to contact with certain components of blood or plasma or components of other body fluids, thereby providing a visual warning function to the wearer. Such protective materials are described in U.S. Pat. No. 5,679,399 to Shlenker et al., for example.

In addition, injection molded thermoplastic articles have heretofore been described having visual color indication of the temperature of the article or the temperature of liquids contained within the molded article. For example, such molded thermoplastic articles having thermochromic properties are described in U.S. Pat. No. 6,513,379 to Meyers et al. As described by Meyers et al., thermochromic pigments were incorporated into the thermoplastic melt used to mold infant drinking cups capable of exhibiting color change in response to cold liquids being placed into the cups. Other thermochromic infant feeding containers are described in, for example, U.S. Pat. No. 4,919,983 to Fremin.

In still other cases, thermochromic pigments may be coated onto the fibers of a fabric material, or printed or painted onto film material. However, topical application may lead to color flaws in the surface of the material if the coating is not uniformly applied, along with the undesirable additional cost of such a post-treatment step. Furthermore, such coatings or paintings may have an undesirable lack of resiliency and durability, and may therefore rub off or flake off of the article onto which they are applied. Cracking and flaking of topically applied pigments may be of particular concern where the article onto which the pigment is applied is intended to be repeatedly flexed or bent back and forth, or intended to be used in a fashion that causes repeated stretching and retraction.

As such, a need currently exists for an improved elastic articles exhibiting temperature-responsive color change.

### SUMMARY OF THE INVENTION

The invention provides for thermochromic elastic articles. The thermochromic elastic articles are capable of changing color in response to changing temperatures. The thermochromic elastic articles include at least one elastic polymeric composition having at least one thermochromic pigment that is substantially uniformly dispersed in the elastic polymeric composition. The elastic polymeric composition includes one or more elastomeric polymers such as elastomeric emulsion-based polymers and elastomeric solution-based polymers. By way of example, the elastomeric polymer or polymers may be such as natural latex polymers and synthetic latex polymers. The thermochromic elastic articles may also desirably include more than one elastic polymeric composition, which may also be selected from elastomeric emulsion polymers and elastomeric solution polymers. Desirably, such additional elastic polymeric compositions may include at least one thermochromic pigment substantially uniformly dispersed therein. In addition, such elastic polymeric compositions may include one or more non-thermochromic pigments.

In addition, the thermochromic elastic article may be desirably provided as a multilayer thermochromic elastic article, wherein a second elastic polymeric composition is substantially the same as the first elastic polymeric composition, or instead may be a substantially different elastic polymeric composition, and/or where the thermochromic pigment(s) in one layer are the same, or differ, from the thermochromic pigment(s) in another layer, if thermochromic pigment(s) are present in such other layers.

The thermochromic pigment or pigments may be present in the elastic polymeric composition(s) independently in an amount between about 0.1 weight percent and about 10 weight percent by weight of the elastic polymeric composition in which the thermochromic pigment exists. More particularly, the thermochromic pigment or pigments may be present in the elastic polymeric composition in an amount between about 0.5 weight percent and about 7 weight percent by weight of the elastic polymeric composition, and still more particularly in an amount between about 1 weight percent and about 5 weight percent by weight of the elastic polymeric composition. A given elastic polymeric composition may desirably include one or more non-thermochromic pigments, and/or may include more than one thermochromic pigment, and the thermochromic pigments may have similar transition temperatures (for example, transition temperatures within about 1 degree Celsius), or may desirably have dissimilar transition temperatures (for example, transition temperatures 4 or more degrees Celsius apart, or even 8 or more degrees Celsius apart).

Furthermore, the invention includes articles of manufacture including the thermochromic elastic articles, such articles of manufacture including gloves, medical wraps, garments, and stress indicating articles.

### BRIEF DESCRIPTION OF THE DRAWINGS

FIG. 1 schematically illustrates a process for forming an exemplary thermochromic elastic article such as a protective glove.

FIG. 2 illustrates an exemplary elastic article according to an embodiment of the invention.

### DEFINITIONS

As used herein and in the claims, the term “comprising” is inclusive or open-ended and does not exclude additional unrecited elements, compositional components, or method steps. Accordingly, the term “comprising” encompasses the more restrictive terms “consisting essentially of” and “consisting of”.

As used herein, the term “thermochromic” refers to ingredients such as pigments and dyes and the like, which undergo a change in color upon a change in temperature. Additionally, the term “thermochromic” refers to materials or articles including such ingredients whereby the materials or articles are capable of exhibiting a color change in response to a change in temperature.

As used herein, the terms “elastic” and “elastomeric” are generally used to refer to a material or article that, upon application of a stretching or biasing force, is capable of being extended or stretched or elongated, in at least one direction, without rupturing, to an extended or elongated dimension which is at least 130 percent of the material's non-extended or “unstretched” dimension, and which upon release of the stretching, biasing force will recover at least about 50 percent of its elongation. By way of example only, an elastic material having a relaxed, unstretched length of 10 centimeters may be elongated to at least about 13 centimeters by the application of a stretching or biasing force. Upon release of the stretching or biasing force the elastic material will recover to a length of not more than 11.5 centimeters.

### DETAILED DESCRIPTION OF THE INVENTION

The present invention provides thermochromic elastic articles. The invention will be described with reference to the following description and Figures which illustrate certain embodiments. It will be apparent to those skilled in the art that these embodiments do not represent the full scope of the invention which is broadly applicable in the form of variations and equivalents as may be embraced by the claims appended hereto. Furthermore, features described or illustrated as part of one embodiment may be used with another embodiment to yield still a further embodiment. It is intended that the scope of the claims extend to all such variations and equivalents.

The thermochromic elastic article includes an elastic polymeric composition having at least one elastomeric polymer. The elastomeric polymer or polymers are selected from any suitable elastomeric emulsion-based polymers and elastomeric solution-based polymers. As used herein, emulsion-based polymers include polymers dispersed in liquids such as aqueous or other liquids. As examples, the elastic polymeric composition used in the thermochromic elastic articles of the present invention may include one or more of a natural rubber latex, a synthetic latex-like polymer such as a nitrile rubber, for example a nitrile butadiene rubber, a polyurethane, styrene butadiene, neoprene, isoprene, styrene-ethylene-butylene-styrene (S-EB-S), styrene-isoprene-styrene (S-I-S), styrene-polybutydiene-styrene (S-B-S), or polyvinyl chloride (PVC) polymers, or any other suitable combinations thereof. Generally speaking, elastomeric polymers which can be formulated into suitable solutions or emulsions, for example solutions or emulsions into which a former can be immersed or dipped, or solutions or emulsions which can be spread into a sheet-form film, for example, are suitable for forming the elastic polymeric composition.

As stated above, an elastic article is capable of stretch and recovery; that is, at a minimum the elastic article is capable of being extended or elongated upon the application of force to an extended length at least 130 percent of its original length, and also capable of recovering at least 50 percent of its elongation. In terms of extensibility or stretchability, more desirably, an elastic material may be stretched or elongated without rupture to an extended, biased length which is at least about 150 percent its relaxed, unstretched length. For many uses or applications, it is desirable for the material to be capable of being stretched without rupture to at least 200 percent of its unstretched length or dimension, and for other uses it is desirable for the material to be capable of being stretched without rupture to at least 250 percent, or even 300 percent (or even more) of its unstretched length or dimension.

In terms of the level of elastic recovery, more desirably, an elastic material will recover at least about 60 percent or more of the extension length. Depending on the desired use or application, an elastic material may desirably be capable of recovering about 75 percent, or even about 85 percent or more of the extension length, and for still other uses an elastic material may desirably be capable of recovering substantially all of the extension length. As a particular numerical example to aid the understanding of the foregoing, for an elastic material capable being stretched to 200 percent of its original length and having a 75 percent recovery, if the material has a relaxed, unstretched length of 10 centimeters, the material may be stretched to at least 20 centimeters by a stretching force, and upon release of the stretching force will recover to a length of not more than 12.5 centimeters.

In addition to the elastomeric polymer, the elastic polymeric composition includes at least one thermochromic pigment that is substantially uniformly dispersed therein. By “substantially uniformly dispersed” in the elastic polymeric composition, it is meant that the thermochromic pigment is relatively well mixed, as by stirring or other means, into the liquid of the emulsion or solution (along with the elastomeric polymer and any other ingredients) prior to the thermochromic elastic article being formed from the elastic polymeric composition. As used herein, thermochromic “pigment” is intended to be inclusive and includes thermochromic pigments provided in powdered or liquid suspension form, thermochromic dyes and thermochromic inks and the like. Leuco dyes and cholesteric liquid crystals are two examples of thermochromic pigments or ingredients that can be used in embodiments of the thermochromic elastic article of the present invention. Any suitable thermochromic pigment or ingredient may be used, so long as it is capable of being thoroughly mixed into and substantially uniformly dispersed within the elastic polymeric composition to be included in the thermochromic elastic article.

Generally such thermochromic pigment materials and ingredients change color in response to changes in temperature. These materials change color at specific temperatures or temperature ranges. Categories of such materials and ingredients include, for example, leuco dyes, available from Color Change Corporation, a company having offices in Streamwood, Ill.; leuco dyes available from Chromatic Technologies Incorporated, a business having offices in Colorado Springs, Colo.; and liquid crystals, available from Hallcrest, Inc., a business having offices in Glenview, Ill.

Examples of leuco dyes include spirolactones such as fluorans or crystal violet lactone, spiropyrans, fulgides, and the like. Generally, such thermochromic systems include at least two chemical components; a leuco dye and a color developer. Leuco dyes are weak organic bases, and become colored in solution when in their protonated form (generally with the proton being donated by a color developer which is, for example, a weak acid). The leuco dye changes from color to colorless, or becomes “decolorized” upon the addition of heat energy. Generally these materials change from colored to colorless over an interval of about 2 to about 7 degrees Celsius—changing temperature shifts the equilibrium between the protonated and unprotonated forms of the leuco dye. As mentioned, color developers are weak acids (acting as proton donors or electron acceptors). Examples of such components include bisphenol A, octyl p-hydroxybenzoate, methyl p-hydroxybenzoate, 1,2,3-triazoles, 4-hydroxycoumarin derivatives, and the like. A third component for an organic dye system (such as a leuco dye) may be a polar solvent, for example an alcohol, ester, ketone, or ether. Examples include lauryl alcohol (i.e., 1-dodecanol), cetyl alcohol (i.e., 1-hexadecanol), and butyl stearate.

Thermochromic ingredients may be employed or provided in various ways. For example, the organic dyes (for example, leuco dyes), may be provided as microencapsulated thermochromic pigment. Another category of thermochromic pigments or ingredients are liquid crystals, such as those available from the above-mentioned Hallcrest, Inc. These thermochromic materials tend to change color over a sharper, more precise temperature range compared to leuco dyes. Examples of such materials include cholesteryl esters, cyano-biphenyls, and the like.

Generally speaking, regardless of the form of the thermochromic pigment or thermochromic ingredient used, the thermochromic pigment will be present in the elastic polymeric composition in an amount sufficient to provide color to the thermochromic elastic article (prior to the thermochromic pigment undergoing transition) and to provide some level of contrast, after undergoing transition/decolorizing, with the previous color of the thermochromic elastic article. Again, generally speaking, such sufficient amounts of thermochromic pigment in the elastic polymeric composition may range from less than about 0.1 weight percent (by weight of the entire elastic polymeric composition) to about 10 weight percent, or greater. In addition, the thermochromic elastic articles may optionally include one or more non-thermochromic pigments or colored elements; i.e., those that do not change color as temperature changes.

Depending on desired end-use application, desired color intensity (and color contrast intensity), presence of other pigments (including non-thermochromic pigments) and the like, the thermochromic pigment in the elastic polymeric composition may range from about 0.5 weight percent to about 7 weight percent of the elastic polymeric composition. More particularly, the thermochromic pigment in the elastic polymeric composition may range from about 1 weight percent to about 5 weight percent of the elastic polymeric composition.

Further details relating to thermochromic ingredients may be found in U.S. Pat. No. 5,741,592 to Lewis, et al. and entitled “Microencapsulated System for Thermal Paper,” and in U.S. Pat. No. 4,028,118 to Nakasuji and entitled “Thermochromic Materials,” both of which are hereby incorporated by reference in their entireties in a manner consistent herewith.

It should be noted that more than one thermochromic pigment or dye may be combined to provide for obtaining multiple color changes as the temperature changes. For example, a thermochromic pigment that undergoes a color change from 23 to 26 degrees Celsius may be combined with a second thermochromic pigment having a color change transition temperature or temperature range from 29 to 31 degrees Celsius. As the combination is warmed from about 20 degrees Celsius to about 35 degrees Celsius, for example, it would proceed through two color changes.

Another version includes a mixture of two or more thermochromic pigments or dyes having different colors and different transition temperatures. For example, one thermochromic pigment may be selected that is red, initially, and then transitions to colorless at, for example, about 29 degrees Celsius. A second thermochromic pigment or dye may be selected that is green, initially, and then transitions to colorless at, for example, about 33 degrees Celsius (or the green pigment itself may consist of other colors, e.g. yellow and blue, that transition approximately together). The combination or mixture of these two thermochromic pigments is initially brownish in appearance. When this mixture is warmed, the red thermochromic pigment transitions to colorless at about 29 degrees Celsius, so that the mixture becomes green in appearance, because that thermochromic pigment has not yet begun to transition to colorless. With increased heating of the mixture, the green thermochromic pigment will also transition to colorless.

As still another example, two or more thermochromic pigments may be combined or mixed together, where the two or more thermochromic pigments undergo color change at approximately the same range of temperatures. For example, two thermochromic pigments may be selected where each undergoes color change transition at a temperature of 23 to 26 degrees Celsius. Furthermore, each of the thermochromic pigments may effect a different change of color at the selected temperature range. Depending on how the thermochromic pigments are combined, the combination could produce a color change different than that produced by each of the thermochromic pigments alone. For example, if a first thermochromic pigment undergoes color change from colorless to yellow at a temperature range of 23 to 26 degrees Celsius, and a second thermochromic pigment undergoes a color change from colorless to blue at a temperature range of 23 to 26 degrees Celsius, then the resulting color change perceived would be from colorless to a greenish color resulting from the mixture of the blue colored and yellow colored pigment.

As noted above, one or more thermochromic pigments may produce a color change from a specific color to a colorless state as the temperature changes. Alternatively, one or more thermochromic pigments may produce a color change from a colorless state to a colored state. By using more than one thermochromic pigment combined in a mixture, the combination can be used to produce multiple color changes. In addition, as mentioned, the thermochromic elastic articles may optionally include one or more non-thermochromic pigments or colored elements; i.e., those that do not change color as temperature changes. By adding such optional pigments the color of the article employing one or more thermochromic pigments can be further manipulated. For example, if a thermochromic pigment normally proceeded from blue to a colorless appearance as the temperature is increased, and a non-thermochromic yellow pigment (that is, a pigment substantially permanent in color) is mixed with the thermochromic pigment then the mixture, when warmed, would proceed from the greenish color of the combined blue thermochromic pigment and yellow non-thermochromic pigment toward a yellow color, as the blue thermochromic pigment transitions to colorless.

As still another example, thermochromic elastic articles may be constructed which exhibit color changing properties upon decrease in temperature. As a simple example of the foregoing, consider a thermochromic elastic article having a yellow non-thermochromic pigment and a red thermochromic pigment, the red thermochromic pigment having a transition temperature somewhat below the ambient environmental temperature. For example, a transition temperature of about 16 degrees Celsius where the ambient environmental temperature is normal room temperature.

At ambient or room temperature (approximately 22 degrees Celsius) this thermochromic elastic article appears yellow due to the yellow non-thermochromic pigment, with the decolorized red thermochromic pigment being substantially non-visible (being at a temperature above its transition temperature). As the thermochromic elastic article is cooled below room temperature and passes the transition temperature of the red thermochromic pigment, the red thermochromic pigment additionally becomes visible, changing the color of the thermochromic elastic article from yellow to an orange color. Similarly, the above-described thermochromic elastic article without the yellow non-thermochromic pigment would appear substantially colorless at ambient or room temperature and become reddish upon cooling. Still other examples and variations of the foregoing coming within the scope of the present invention will be readily apparent to those having ordinary skill in the art.

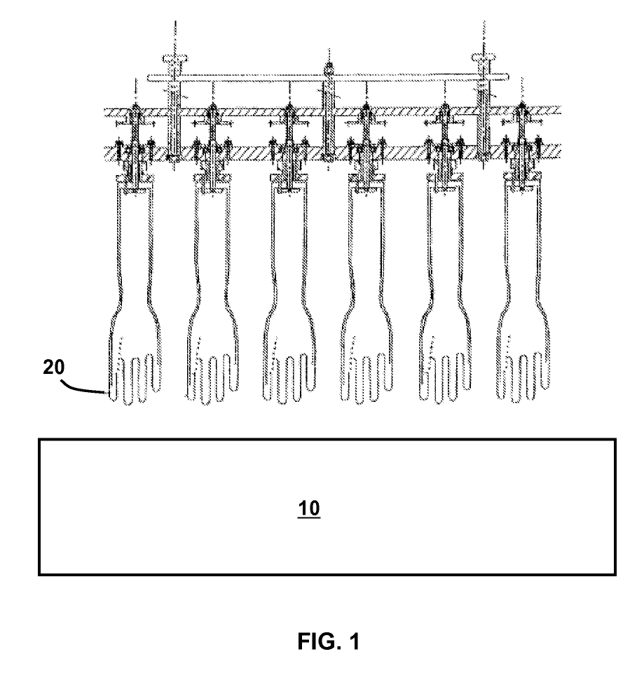

As an exemplary process for forming a thermochromic elastic article of the invention, FIG. 1 schematically illustrates a process for making a thermochromic elastic article in the form of, for example, a protective glove such as a surgical glove or patient examination glove. In the process, an elastic polymeric composition may be produced as a latex compounding emulsion.

The latex compounding emulsion may contain, for example, a natural rubber latex polymer as the emulsion polymer and contain a powdered or liquid-based thermochromic pigment. The thermochromic pigment is thoroughly mixed into the latex compounding emulsion so that the elastic polymeric composition contains substantially uniformly distributed thermochromic pigment. After the thermochromic-containing latex compounding emulsion is produced, it is provided into a bath 10. Next, one or more formers 20 is provided. As shown in FIG. 1, the former(s) 20 are provided as a plurality of formers on a rack device for batch processing of multiple thermochromic elastic articles at once. Of course, more continuous process may also desirably be utilized. The former 20 or the surface of former 20 may be or include any suitable material, such as, for example, ceramic, porcelain, glass, metal, bamboo or certain fluorocarbon plastics.

The former 20 is then immersed or dipped into a latex compounding emulsion. As illustrated in FIG. 1, former 20 may desirably be in the shape of a human hand for the production of gloves, but one skilled in the art will recognize that the former may be any suitable size or shape to produce various thermochromic elastic articles. The former 20 may desirably be coated with a coagulant or coagulant composition such as are known in the art which act to make some of the polymer in the latex compounding emulsion become locally unstable, and thereby more readily coagulate on the surface of the former 20.

In addition, the former 20 may desirably be heated to assist in the coagulation process. The thickness of the elastic polymeric composition coating onto the former 20 is generally affected positively by dwell time; that is, the amount of time the former 20 is immersed in the latex compounding emulsion determines the thickness of the elastic polymer film forming on the former 20. Increasing the dwell time of the former in the latex compounding emulsion causes the thickness of the elastic polymer film to increase. After the desired amount of time, the former 20 is withdrawn from the latex compounding emulsion in the bath 10, and the coagulated elastic polymer layer is allowed to coalesce fully on the former 20.

Once the former 20 is removed from the latex compounding emulsion, the elastic polymeric composition on the former 20 may be further processed, as desired. For example, the elastic polymeric composition may desirably be gelled or cured with heat to strengthen the elastomeric film, leached with flowing hot water to remove impurities, if any, and/or may have various coatings applied, and the like, although it should be noted that specific appropriate finishing steps will depend upon the make up of the elastic polymer composition. As an example, the temperature used for heat curing may vary widely depending on the particular elastic polymeric composition, generally ranging from less than 70 degrees Celsius to 140 degrees Celsius, or more.

After the elastic polymer film of the glove has dried, additional layers of the same elastic polymeric composition may desirably be applied by subsequent immersions of the former 20 into the latex compounding emulsion, if desired to increase the thickness of the elastic polymeric composition in the thermochromic elastic article. The overall thickness of the elastic polymeric composition in the thermochromic elastic article may depend on many parameters including, for example, dwell time in the compounding emulsion, the number of times the former is immersed into the compounding emulsion, and the make up of the compounding emulsion. By way of example only, the total thickness of the elastic polymer layer of the glove formed on the former may desirably range anywhere from as thin as 50 micrometers to about 500 micrometers, or more, and more particularly from about 70 micrometers to about 150 micrometers. Of course, for heavier use applications, for example use as an industrial protective glove or chemical protective glove, it may be desirable for the elastic polymer layer to be considerably thicker.

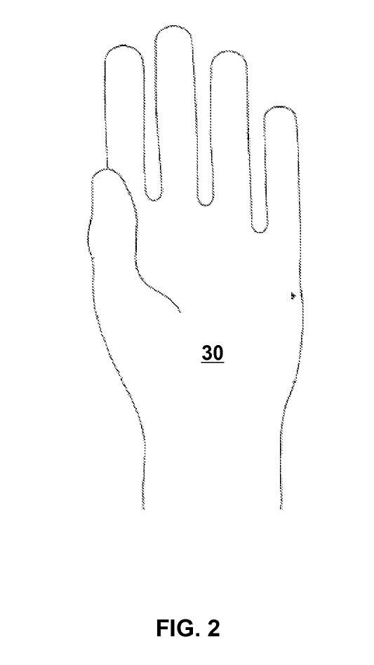

In any event, once the elastic polymer layer has suitably cured, the thermochromic elastic article (in this instance, a glove) may be removed from the former 20 in order to produce the protective glove 30 (FIG. 2).

As was mentioned above, combinations of the elastomeric polymers or copolymers may be in a single layer of a thermochromic elastic article. Therefore, the layer or layers of the elastic polymeric composition formed into the elastic film layer on the former as described with respect to FIG. 1 may include more than one elastomeric emulsion or solution polymer, and may further include more than one thermochromic pigment. Alternatively, combinations of the elastomeric polymers or copolymers may be provided in separate layers of a thermochromic elastic article, such as in a multilayer thermochromic elastic article having layers that differ, one from the other. For example, the various layers may differ by having differing elastomeric polymer types, differing pigments (thermochromic and/or non-thermochromic) or combinations of pigments, or both. In addition, by “differing” thermochromic pigments it is meant that the thermochromic pigments may differ either in terms of pigment color or pigment transition temperature, or both.

In one beneficial embodiment, the thermochromic elastic article may be provided in the form of a protective glove as described above. However, in other embodiments, such a protective glove may be configured to provide additional information to the wearer or others. For example, the selection of the color change transition temperature or temperature range may be configured to provide information to the wearer concerning the state of the gloves themselves, or information relating to the state of the surrounding environment. For example, the color change transition can forewarn the user of impending contact with a too-hot surface or liquid. As another example, protective gloves may be configured to serve as a duration-of-wear indicator, whereby the thermochromic pigment(s) in the thermochromic elastic article change color or become colorless when a final selected temperature endpoint has been reached after a certain period of wear, signaling the need to replace the protective gloves with a fresh pair of gloves.

As a specific example of the foregoing glove capable of providing a warning for an uncomfortable level of heat, a protective glove may be constructed having two thermochromic pigments, wherein the pigments have two distinct transition temperatures/temperature ranges. For example, the protective glove may contain a red thermochromic pigment having a transition temperature of about 50 degrees Celsius and a blue thermochromic pigment having a transition temperature of about 40 degrees Celsius. At ambient and body temperatures, the glove would appear purple in color. However, as such a glove comes into contact with objects or fluids warmer than about 40 degrees Celsius, the blue thermochromic pigment will transition to colorless, leaving the red thermochromic pigment visible, and the protective glove will begin becoming more reddish in appearance. This provides a clear signal to the wearer that a temperature threshold has been passed. Finally, if the user continues to make contact with objects or fluids as warm as 50 degrees Celsius or warmer, the glove will completely decolorize to signal to the wearer that another temperature threshold has been surpassed. Of course, one skilled in the art will recognize that other color schemes and other transition temperatures may be selected, and/or that more than two thermochromic pigments and/or more than two transition temperatures may be utilized.

In another beneficial embodiment, the thermochromic elastic article may be provided in the form of a protective glove capable of providing a warning mechanism to the wearer, when the protective glove is punctured or ruptured or otherwise breached. As a specific example, a thermochromic elastic article in the form of a protective glove may be provided wherein at least one of the thermochromic pigment or pigments in the elastic polymeric composition has a transition temperature whereby the color changes if the temperature is less than about 26 to 28 degrees Celsius, for example. In this case, a tear or even a small puncture in the protective glove may produce a cooling effect due to evaporative cooling of moisture from the wearer's skin. If the evaporative cooling reduces the temperature of the thermochromic elastic article in the region surrounding the breach to a temperature below the transition temperature of the thermochromic pigment (28 degrees Celsius in this example), the region surrounding the breach will undergo color change to signal both the fact that a breach has occurred and the specific location of the breach.

### EXAMPLES

### Example 1

As a specific example of an embodiment of the foregoing, a temperature responsive elastic color changing article was produced as follows. First, a base latex compounding emulsion was produced using Synthomer in deionized water. Synthomer is a nitrile rubber latex, specifically a carboxylated butadiene-acrylonitrile rubber latex, available from Synthomer Ltd. of Harlow, Great Britain. The base latex compounding emulsion additionally included about 1 weight percent ammonia, about 2 weight percent curing/crosslinking agent, and about 1 weight percent kaolin clay as a filler and opacifier.

For Example 1, 3 grams of red thermochromic pigment powder and 3 grams of blue thermochromic pigment powder, both available from Color Change Corporation, Streamwood, Ill., were mixed together in their powdered form to produce 6 grams of a purple colored powder. The color transition temperature of each pigment was 31 degrees Celsius. Next, 2.5 grams of the mixed purple powder was added to 250 milliliters of the latex compounding emulsion and mixed together by stirring to form a latex compounding emulsion having about 1 weight percent of the thermochromic pigment ingredient.

Next, a cylinder-shaped former was heated to 90 degrees Celsius and dipped into the pigment-containing latex compounding emulsion to coat the former. The former was placed into an oven heated at 90 degrees Celsius to cure for a 10 minute period. When removed from the oven, the thermochromic elastic article coated onto the former was essentially colorless, but upon cooling below the transition temperature (31 degrees Celsius) reverted to the purple color. When the thermochromic elastic article was removed from the former, it was capable of repeatedly changing color from purple to colorless and back to purple as it was warmed from ambient temperature (approximately 20 degrees Celsius), to a temperature above 31 degrees Celsius, and then allowed to cool again to ambient temperature.

To verify elasticity of the Example material, a sample of the elastic film material thus made was stretched and released by hand to ensure the material was capable of elastic stretch and recovery. A strip of the elastic film material measuring 11 centimeters long and 1 centimeter wide, and having a thickness of about 0.5 millimeter, was held at each end by thumb and forefinger, leaving 9 centimeters of the film material exposed between the gripped ends as measured on a ruler. The film was then stretched by hand to 18 centimeters (i.e., extended to 200 percent of its original length), and then the stretching force was removed and the film allowed to relax. The film initially relaxed or recovered to a length of 9.5 centimeters (i.e., demonstrating an immediate recovery of about 94 percent), and after 1 minute, the film material had returned to its original length of 9 centimeters (100 percent recovery).

### Example 2

For Example 2, two thermochromic pigment aqueous-based inks, magenta and blue, were obtained from Matsui International of Gardena, Calif. The color transition temperature of each pigmented ink was 31 degrees Celsius. 40 grams of the magenta ink was mixed with 6 grams of the blue ink, to form a purple colored ink. Next, 2.5 grams of the purple colored ink was added to 250 milliliters of the latex compounding emulsion (described above with respect to Example 1) and mixed together by stirring to form a latex compounding emulsion having about 1 weight percent of the thermochromic pigment ingredient.

Next, another cylinder-shaped former was heated to 90 degrees Celsius and dipped into the pigment-containing latex compounding emulsion to coat the former. The former was placed into an oven heated at 90 degrees Celsius to cure for a 10 minute period. When removed from the oven, the thermochromic elastic article coated onto the former was essentially colorless, but upon cooling below the transition temperature (31 degrees Celsius) reverted to the purple color. As with Example 1, when the thermochromic elastic article of Example 2 was removed from the former, it was capable of repeatedly changing color from purple to colorless and back to purple as it was warmed from ambient temperature (approximately 20 degrees Celsius), to a temperature above the 31 degrees Celsius transition temperature, and then allowed to cool again to ambient temperature.

### Example 3

For Example 3, the concentration of the thermochromic pigment ingredient was increased in order to enhance the color intensity of the thermochromic elastic article and to increase the contrast between the initial and de-colorized state of the thermochromic elastic article. For Example 3, the same mixture of the two thermochromic pigment aqueous-based inks (mixture of magenta and blue thermochromic pigment inks) was used, except that 10.5 grams of the inks mixture was added to 450 milliliters of the latex compounding emulsion (described above with respect to Example 1) and mixed together by stirring to form a latex compounding emulsion having about 2.3 weight percent of the thermochromic pigment ingredient. Next, another former (for Example 3, a hand-shaped former) was heated to 90 degrees Celsius and dipped into the pigment-containing latex compounding emulsion to coat the hand-shaped former. The former was placed into an oven heated at 90 degrees Celsius to cure for a 10 minute period. When removed from the oven, the thermochromic elastic article coated onto the former was essentially colorless, but upon cooling below the transition temperature (31 degrees Celsius) reverted to the purple color.

The thermochromic elastic article/glove on the former was then exposed to warm water from the tap, whereupon it promptly decolorized, and then again reverted to purple color as it cooled. In addition, as with the above-described Examples, when the thermochromic elastic article/glove of Example 3 was removed from the former, it was also capable of repeatedly changing color from purple to colorless and back to purple as it was warmed from ambient temperature (approximately 20 degrees Celsius), to a temperature above the 31 degrees Celsius transition temperature, and then allowed to cool again to ambient temperature.

The thermochromic elastic articles described herein are highly suited for use in medical care products, protective wear garments, and the like. Many other uses are possible. For example, the thermochromic elastic articles may be incorporated into or used in other medical devices or products such as circulation monitors and post-surgical coverings for extremities, and compressive elastic wraps such as medical wraps capable of indicating heating or cooling states. As an example, an elastic bandage made from or including a thermochromic elastic article of the invention may be used alone as a compressive wrap capable of producing visual signal of possible presence of wound infection if the thermochromic elastic article is configured to undergo color change at temperatures somewhat above normal human skin temperature, and/or may be capable of visual indicating a state of reduced circulation in an extremity if the thermochromic elastic article is additionally or alternatively configured to undergo color change at temperatures somewhat below normal human skin temperature.

As still another example, the thermochromic elastic article may be provided as an elastic compressive wrap material used to maintain proper positioning of heating or cooling therapy packs, and be capable of providing at-a-glance feedback to a medical professional or other caregiver as to the status or current performance of the heating or cooling pack. For example, a thermochromic compressive wrap configured to undergo color change at a temperature moderately above (and/or below) normal human skin temperature can provide visual indication when the heating or cooling functionality of the therapy pack has been exhausted.

The thermochromic elastic articles may also be beneficially incorporated into garments, for example into children's toilet training pants, disposable swimwear, or other pant-type or diaper-like products where it is desirable to have an elastic member capable of indicating temperature change. Incorporation into other types of garments where stretchable color-changing properties are desired is also of course possible. As a specific example, such pant-type products often include elastic side panel materials to ensure a secure and comfortable fit. The thermochromic elastic articles may be provided as or incorporated into the elastic side panel materials, or in other portions of such garments, to provide temperature indicating properties along with elastic properties.

Such an elastic panel may include the thermochromic elastic article as a layer in a multi-layered laminate material, and/or include the thermochromic elastic article as an elastic portion of the material in an adjacent relationship with one or more other elastic or non-elastic materials. By way of example, it may be desirable to have the thermochromic elastic article provided with more cloth-like aesthetic properties on a user-facing or skin-facing side by layering or laminating the elastic article with a cloth-like facing. Exemplary cloth-like facings include fabrics such as woven, knitted and nonwoven fabrics. Desirably, such a cloth-like facing may be extensible so as not to impede the extensibility of the thermochromic elastic article.

As still another example, the thermochromic elastic articles of the invention may be provided in the form of an article capable of indicating input of mechanical work energy by undergoing a color change transition as the article becomes warmed due to repetitive stress (i.e., by repetitive flexing or stretching of the article). Such a stress indicating article can serve to signal impending failure of the article, or may instead serve as a semi-quantitative measure of the amount of work performed. As one example, elastic bands are often used for exercise programs, both for general fitness and for purposes of medical rehabilitation necessitated by injury or disease. Such elastic bands are commonly provided in the form of flat film sheets or flat film ribbons, and are also commonly provided in the form of tubes, such as generally cylindrical tubes, for example. Elastic bands may also be provided in the form of shaped solid bands, such as for example in the form of solid cylindrical bands or solid bands having a generally oval or square cross section, and the like.

The thermochromic elastic articles may be provided in the form of stress indicating articles such as exercise bands that are capable of indicating whether a “light”, “moderate” or “strenuous” level of exercise has been achieved by the user, depending on the transition temperature of the thermochromic pigment(s) incorporated into such an exercise band. For example, a lower transition temperature thermochromic pigment(s) may be selected for use in a thermochromic elastic article for lighter intended workouts, and a higher transition temperature thermochromic pigment(s) may be selected for use in a thermochromic elastic article for more strenuous intended workouts.

In addition, a single thermochromic elastic article may be capable of indicating any or all of the above. For example, a thermochromic elastic article provided as a stress indicating exercise band may be provided having multiple thermochromic pigments P1 (blue), P2 (yellow) and P3 (red) all in the colored state at an intended ambient temperature, and having distinct transition temperatures respectively T1, T2 and T3, and where T1<T2<T3. Prior to beginning exercise, the thermochromic elastic exercise band may have a generally brownish appearance resulting from the mixture of the three primary colored pigments. After a light amount of exercise, as the band warms, the blue pigment decolorizes and the exercise band becomes generally orange in appearance. After a moderate amount of exercise, as the band warms further, the yellow pigment decolorizes and the exercise band becomes generally reddish in appearance. Finally, upon further exercise, as the band warms still further, the red pigment decolorizes and the exercise band becomes generally colorless or whitish in appearance.

While the thermochromic elastic articles disclosed and described herein have been described primarily with respect to a number of exemplary embodiments, it is envisioned that many other embodiments of the thermochromic elastic articles may be suitably and desirably constructed. For example, thermochromic elastic articles may desirably be provided in the form of elastic novelty items. As just one specific example, the thermochromic elastic article may be provided in the form of user-inflated elastic balloons. Such thermochromic elastic balloons can provide enjoyment and amusement by changing color when held in (and warmed by) the hands.

While various patents have been incorporated herein by reference, to the extent there is any inconsistency between incorporated material and that of the written specification, the written specification shall control. In addition, while the invention has been described in detail with respect to specific embodiments thereof, it will be apparent to those skilled in the art that various alterations, modifications and other changes may be made to the invention without departing from the spirit and scope of the present invention. It is therefore intended that the claims cover all such modifications, alterations and other changes encompassed by the appended claims.

1. A thermochromic elastic article comprising a first elastic polymeric composition, the first elastic polymeric composition comprising an elastomeric polymer selected from the group consisting of elastomeric emulsion polymers and elastomeric solution polymers, the first elastic polymeric composition further comprising a first thermochromic pigment, and wherein the first thermochromic pigment is substantially uniformly dispersed in the elastic polymeric composition.

2. The thermochromic elastic article of claim 1 wherein the first elastic polymeric composition comprises at least one elastomeric polymer selected from the group consisting of natural latex polymers and synthetic latex polymers.

3. The thermochromic elastic article of claim 1 wherein the first elastic polymeric composition comprises between about 0.1 weight percent and about 10 weight percent of thermochromic pigment.

4. The thermochromic elastic article of claim 1 wherein the first elastic polymeric composition comprises between about 0.5 weight percent and about 7 weight percent of thermochromic pigment.

5. The thermochromic elastic article of claim 1 wherein the first elastic polymeric composition comprises between about 1 weight percent and about 5 weight percent of thermochromic pigment.

6. The thermochromic elastic article of claim 2 wherein the first elastic polymeric composition comprises between about 0.5 weight percent and about 10 weight percent of thermochromic pigment.

7. The thermochromic elastic article of claim 1, wherein the first elastic polymeric composition comprises a second thermochromic pigment.

8. The thermochromic elastic article of claim 7, the first thermochromic pigment having a first transition temperature and the second thermochromic pigment having a second transition temperature, and wherein the difference between the first transition temperature and the second transition temperature is not more than about 1 degree Celsius.

9. The thermochromic elastic article of claim 7, the first thermochromic pigment having a first transition temperature and the second thermochromic pigment having a second transition temperature, and wherein the difference between the first transition temperature and the second transition temperature is at least about 2 degrees Celsius.

10. The thermochromic elastic article of claim 7, the first thermochromic pigment having a first transition temperature and the second thermochromic pigment having a second transition temperature, and wherein the difference between the first transition temperature and the second transition temperature is at least about 4 degrees Celsius.

11. The thermochromic elastic article of claim 1, further comprising a second elastic polymeric composition, the second elastic polymeric composition comprising an elastomeric polymer selected from the group consisting of elastomeric emulsion polymers and elastomeric solution polymers.

12. The thermochromic elastic article of claim 11 wherein the first elastic polymeric composition comprises between about 0.1 weight percent and about 10 weight percent of thermochromic pigment, and wherein the second elastic polymeric composition independently comprises between about 0.1 weight percent and about 10 weight percent of a thermochromic pigment.

13. The thermochromic elastic article of claim 12 wherein the first elastic polymeric composition comprises between about 0.5 weight percent and about 7 weight percent of thermochromic pigment, and wherein the second elastic polymeric composition independently comprises between about 0.5 weight percent and about 7 weight percent of thermochromic pigment.

14. The thermochromic elastic article of claim 11 provided as a multilayer thermochromic elastic article wherein the second elastic polymeric composition is substantially the same as the first elastic polymeric composition.

15. The thermochromic elastic article of claim 12 provided as a multilayer thermochromic elastic article wherein the thermochromic pigment in the second elastic polymeric composition differs from the thermochromic pigment in the first elastic polymeric composition.

16. The thermochromic elastic article of claim 15, the thermochromic pigment in the first elastic polymeric composition having a first transition temperature and the thermochromic pigment in the second elastic polymeric composition having a second transition temperature, wherein the difference between the first transition temperature and the second transition temperature is at least about 2 degrees Celsius.

17. The thermochromic elastic article of claim 16, wherein the difference between the first transition temperature and the second transition temperature is at least about 4 degrees Celsius.

18. The thermochromic elastic article of claim 17, wherein the difference between the first transition temperature and the second transition temperature is at least about 8 degrees Celsius.

19. The thermochromic elastic article of claim 1, wherein the thermochromic elastic article further includes at least one non-thermochromic pigment.

20. An article of manufacture comprising the thermochromic elastic article of claim 1, said article of manufacture selected from the group consisting of a glove, a medical wrap, a garment and a stress indicating article.

21. An article of manufacture comprising the thermochromic elastic article of claim 16, said article of manufacture selected from the group consisting of a glove, a medical wrap, a garment and a stress indicating article.
